(19) United States
(12) Patent Application Publication
(10) Pub. No.: US 2008/0305666 A1
(43) Pub. Date: Dec. 11, 2008

(54) Structure for electronic card connector

(76) Inventors: Chun Chen Lin, Yilan City (TW); An-Yu Yu, Keelung City (TW); Leland Wang, Walnut, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,427

(22) Filed: Jun. 11, 2007

(51) Int. Cl. H01R 13/15

(52) U.S. Cl. 439/260

(57) ABSTRACT

A structure for an electronic card connector is comprised of an insulating body having a universal card slot on a side thereof, a first group of pins, and a pressing unit disposed on the first surface. The universal card slot is comprised of a first surface thereinside and the first group of pins is comprised of a plurality of conducting terminals. Furthermore, the pressing unit is comprised of a contacting portion disposed higher than the first group of pins, a plurality of pivoting portions, and a pressing portion. A plurality of pivoting holes disposed on the surface are connected with the pivoting portion of the pressing unit and the pressing portion abuts against free ends of the conducting terminals. The structure is used to prevent the conducting terminals from improper contact with the inserted electronic card.

### BACKGROUND OF THE INVENTION

1. Field of the Invention

The present invention relates to a structure for an electronic card connector, and in particular to a structure for an electronic card connector having a pressing unit.

2. Description of Prior Art

With the amounts of information and data increasing at rapidly increasing rates, it is necessary for electronic storage devices to have high storage capacities. For example, compact discs (CDs), digital video discs (DVDs) and portable hard disk drives (HDDs) have been developed to meet such high storage requirements. Electronic cards also have the advantages of high capacity and small size. As such, they are commonly provided for a mobile electronic device as an important storage media.

Many kinds of electronic devices such as mobile phones, digital cameras, laptop computers and personal digital assistants (PDAs) are designed for connecting with electronic cards so as to easily and conveniently transfer the data stored in the electronic device.

However, electronic cards are classified into different specifications such as Multi-Media Cards (MMCs), Secure Digital Cards (SDs), and Memory Stick Cards (MSs). The above described electronic cards with different specifications are used in different devices and are produced by various corporations. A card connector having multiple abilities for reading/writing data in the electronic cards with various specifications is necessary for a consumer.

Several groups of pins are disposed inside an electronic card connector and they are arranged according to the protocol of the specifications. When an electronic card is inserted into a universal connector, the connecting portion of the electronic card connects electrically with the corresponding pins so that the data stored in the inserted electronic card can be read.

In the conventional connector, the structure has some disadvantages which are described as follows:
1. When an electronic card is inserted into an electronic card connector, the electronic card improperly contacts the unused pins so that the pins are easily damaged. Furthermore, the casing of the electronic card is sometimes made of conductive materials and the contact between the casing of the electronic card and the pins can form a short circuit causing the failure of the electronic card.
2. A structure having various surfaces is employed for avoiding improper contact between the casing of the electronic card and the pins. The different groups of pins are disposed on the surfaces at different heights. However, the structure using the different surfaces is so thick that the size of the electronic card connector is increased.

Therefore, in view of this, the inventor proposes the present invention to overcome the above described problem based on his expert experience and deliberate research.

### SUMMARY OF THE INVENTION

The primary object of the present invention is to provide a structure for an electronic card connector having a pressing unit. The structure of the pressing unit presses the unused conducting terminals to move downwardly when an electronic card is inserted into the electronic card connector and the movement of the unused conducting terminals prevents the unused conducting terminals from improper contact with the casing of the electronic card.

In order to achieve the above object, the present invention provides a structure for an electronic card connector. The structure comprises an insulating body having a universal card slot formed on a side thereof, a first group of pins, and a pressing unit disposed on the first surface. The universal card slot is comprised of a first surface thereinside and the first group of pins is comprised of a plurality of conducting terminals. Furthermore, the pressing unit is comprised of a contacting portion that is disposed higher than the first group of pins, a plurality of pivoting portions, and a pressing portion.

Wherein a plurality of pivoting holes is disposed on the first surface, the pivoting portion of the pressing unit is pivotedly connected with the pivoting holes, and a lower surface of the pressing portion abuts against free ends of the connecting terminals. When an electronic card is inserted into the electronic card connector, a lower casing of the electronic card presses the pressing unit to move downwardly and the conducting terminals are pressed downwardly by the pressing unit.

In order to achieve the above object, the present invention provides a structure for an electronic card connector. The structure is comprised of an insulating body having a universal card slot on a side thereof, a plurality of groups of pins is disposed respectively on the surfaces, and at least one pressing unit is disposed on the surfaces. The universal card slot is comprised of a plurality of surfaces thereinside. Each group of pins is comprised of a plurality of conducting terminals and each pressing unit is disposed higher than the group of pins disposed on the same surface.

Furthermore a lower surface of each pressing unit abuts against free ends of the connecting terminals of the group of pins on the same surface.

When an electronic card is inserted into the electronic card connector, a lower casing of the electronic card presses the pressing unit to move downwardly and the conducting terminals are pressed downwardly by the pressing unit.

The present invention provides a pressing unit, and the pressing unit disposed higher than the conducting terminals prevents the unused groups of pins from improper contact with the inserted electronic card.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is an exploded view of the embodiment of the structure for an electronic card connector according to the present invention;

FIG. 2 is an assembled view of the embodiment of the structure for an electronic card connector according to the present invention;

FIG. 3A is a perspective view showing the pressing unit of the electronic device connector according to the present invention; and

FIG. 3B is a schematic view showing the details of the portion B of FIG. 3A.

### DETAILED DESCRIPTION OF THE INVENTION

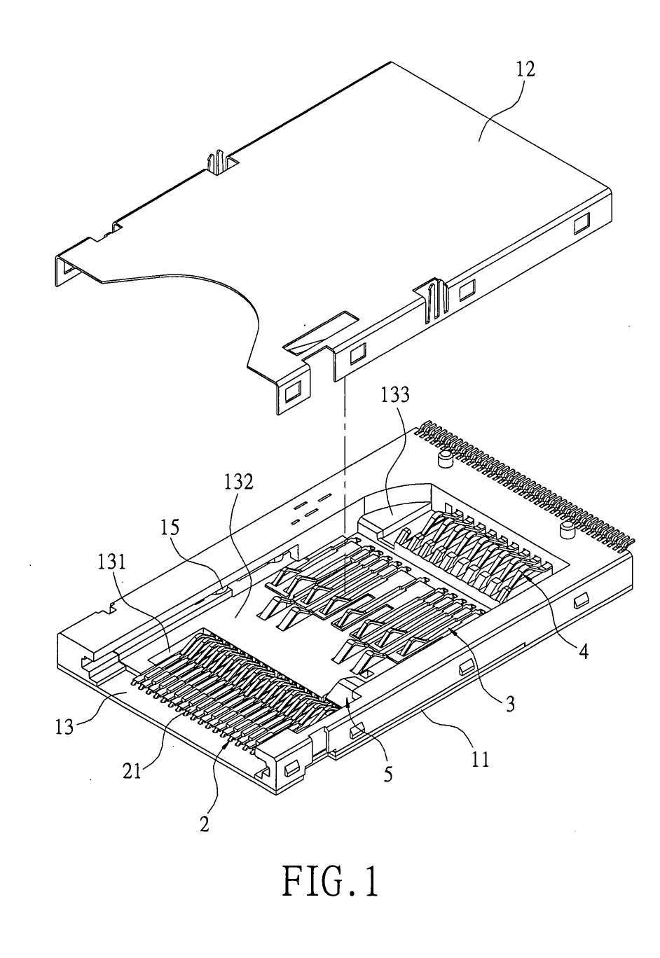

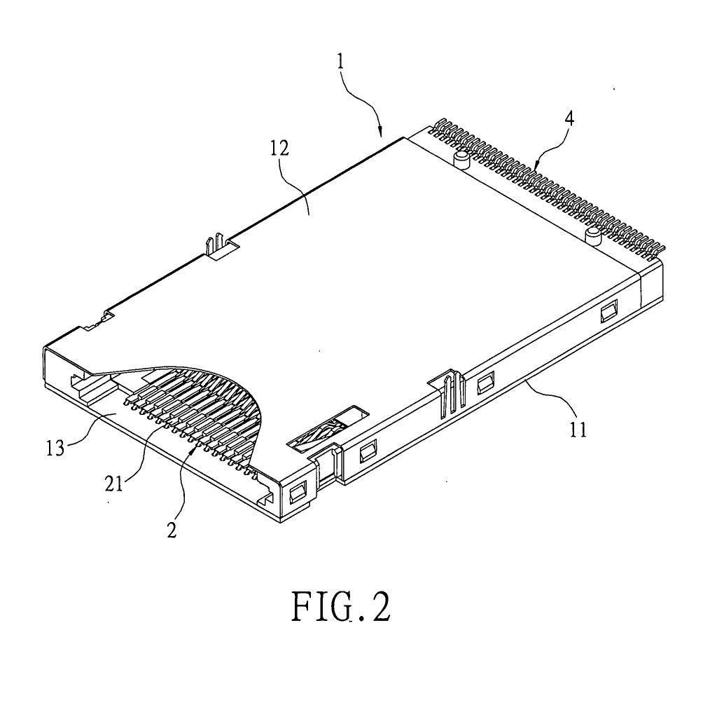

With reference to FIGS. 1 to 2, the present invention provides a structure for an electronic card connector. The structure for an electronic card connector is comprised of an insulating body 1, a first group of pins 2, a second group of pins 3, a third group of pins 4, and a pressing unit 5. The insulating body 2 has a base 11 and a cover 12 for covering the base 11. A universal card slot 13 is defined between the base 11 and the cover 12, and an opening is set on a side of the insulating body 2 for communicating with the universal card slot 13. The universal card slot 13 has a plurality of stepwise surfaces comprising a first surface 131, a second surface 132, and a third surface 133.

Among the above-mentioned surfaces, the first surface 131 is closest to the opening and the third surface 133 is defined away from the opening. The first group of pins 2, a second group of pins 3, and a third group of pins 4 are respectively disposed on the first surface 131, the second surface 132, and the third surface 133. When a card with a first specification such as an XD electronic card is inserted into the universal card slot 13, a connecting portion of the XD electronic card electrically connects with the first group of pins 2 on the first surface 131. Similarly, a card with a second specification such as an SD, MMC or MMC⁺ electronic card and a card with a third specification such as an MS electronic card can be respectively electrically connected with the second group of pins 3 on the second surface 132, and the third group of pins 4 on the third surface 133. Thereby, electronic cards of different specifications can be electrically connected to the corresponding groups of pins so that the data in the electronic cards can be read and/or written. Furthermore, a positioning device 15 can be disposed on either of or both internal surfaces of the lateral sides of the insulating body 1 so as to fasten the inserted electronic card.

The first group of pins 2 is disposed on the first surface 131 of the universal card slot 13. The first group of pins 2 is comprised of a plurality of conducting terminals 21 and each conducting terminal 21 has a free end 211 on one side thereof. The conducting terminals 21 are arranged correspondingly to the first specification such as the standard protocol of an XD electronic card to connect with the inserted electronic card and proceed with data transmission.

The second group of pins 3 is disposed on the second surface 132 of the universal card slot 13. The second group of pins 3 is comprised of a plurality of conducting terminals. The conducting terminals are arranged correspondingly to the second specification such as the standard protocol of SD, MMC or MMC⁺ electronic cards to connect with the inserted electronic card and proceed with data transmission.

The third group of pins 4 is disposed on the third surface 133 of the universal card slot 13. The third group of pins 4 is comprised of a plurality of conducting terminals. The conducting terminals are arranged correspondingly to the third specification such as the standard protocol of an MS electronic card to connect with the inserted electronic card and proceed with data transmission.

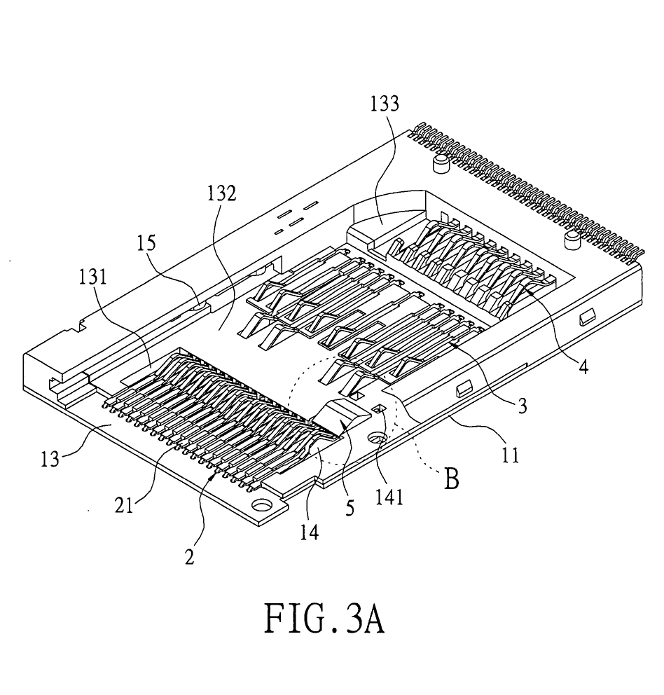

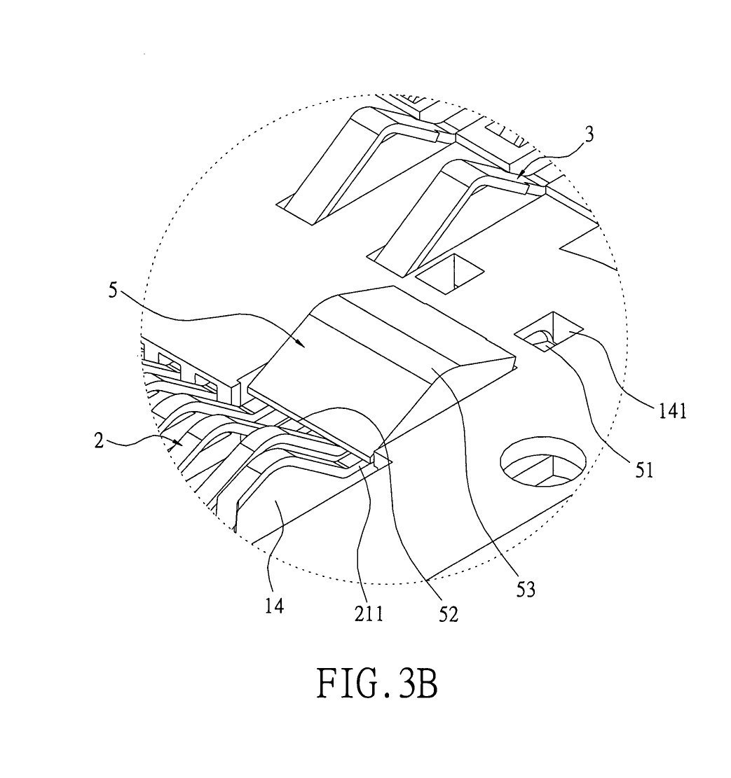

Please refer to FIGS. 3A and 3B, the first surface 131 has a receiving recess 14 and a plurality of pivoting holes 141. The pressing unit 5 is disposed inside the receiving recess 14 and the receiving recess 14 has a predetermined depth for allowing the pressing unit 5 to move downwardly. The pressing unit 5 is formed as a protruding body and the height of the pressing unit 5 is higher than that of the first group of the pins 2. The pressing unit 5 comprises a plurality of pivoting portions 51, a pressing portion 52 and a contacting portion 53. The pressing unit 5 is movably connected to the first surface 131 via the connection between the pivoting portions 51 and pivoting holes 141. Moreover, the lower surface of the pressing portion 52 contacts the free ends 211 of the conducting terminals 21.

When inserting a card of a second specification such as an SD, MMC or MMC⁺ electronic card, the card has to pass through the opening and the first surface 131 to arrive at the second surface 132 to connect electronically with the second group of pins 3. Similarly, when inserting a card of the third specification such as an MS electronic card, the card has to pass through the opening, the first surface 131, and the second surface 132 to arrive at the third surface 133 and to connect electronically with the third group of pins 4. Accordingly, when an SD electronic card or an MS electronic card is inserted into the universal card slot 13, they will improperly contact the first group of pins 2 on the first surface 131 and the first group of pins 2 may be bent or broken because of the improper contact. Furthermore, because the casing of the electronic card is sometimes made by conductive materials such as metal, the improper contact between the conductive casing of the electronic card and the first group of pins 2 forms a short circuit to cause an improper reading/writing of the data recorded onto the electronic card, even possibly resulting in a failure of the electronic card. Please refer to FIGS. 3A and 3B, in which the structure for an electronic card connector has a pressing unit 5 disposed on the first surface 131, and the height of pressing unit 5 is higher than that of the first group of pins 2. When an SD electronic card or an MS electronic card is inserted into the universal card slot 13, they contact the pressing unit 5 first because of the difference in height. The contacting portion 53 of the pressing unit 5 abuts against the bottom surface of the inserted electronic card and the pressing unit is pressed to move downwardly. Furthermore, the free ends 211 of the terminals 21 contact the lower surface of the pressing portion 52 of the pressing unit 5. Thus, the free ends 211 of the terminals 21 are pushed to move downwardly due to the movement of the pressing unit 5. In other words, the inserted electronic card merely contacts with the pressing unit 5 on the first surface 131 and contacts electronically with the predetermined group of pins 3 or 4. When the inserted electronic card is extracted from the universal card slot 13, the free ends 211 of the terminals 21 go back to their normal position because of their elastic characteristics. The pressing unit 5 also rotates back via the elastic force of the terminals 21. However, a user can usually insert a card of a first specification such as an XD electronic card into the universal card slot 13 to contact electronically with the first group of pins 2, because the length of the electronic card is too short to reach the position of the pressing unit 5. Accordingly, the pressing unit 5 does not effect the connection between the card of first specification and the first group of pins 2. In another embodiment, the structure of the electronic card connector is comprised of more than one pressing unit 5. For example, two pressing units 5 are respectively disposed on the first surface 131 and the second surface 132 (not shown). When a card of a third specification such as an MS electronic card is inserted, the two pressing units 5 avoid improper contact between the inserted card and the first group of pins 131 or the second group of pins 132. In FIG. 3B the pressing portion 52 of the pressing unit 5 abuts against predetermined terminals 21, and in another embodiment, the pressing portion 52 can abut against all of the terminals 21 (not shown). In other words, the mounting and the positioning of the pressing unit 5 are adjustable depending on the application thereof.

To sum up, the present invention provides some advantages as described below:
1. The structure for an electronic card connector has a pressing unit 5 disposed inside the receiving recess 14 and the receiving recess 14 and has a predetermined depth allowing the pressing unit 5 and the terminals 21 to move downwardly. Moreover, because the pressing unit 5 is disposed higher than the terminals 21, the pressing unit 5 prevents the inserted electronic card from contacting with the terminals 21. Thus, the terminals 21 are protected from damage caused by an inserting force.
2. The casing of electronic card is sometimes made by conductive materials, and improper contact between the conductive casing and the terminals 21 induces a short circuit. The present invention provides a pressing unit 5 to avoid the improper contact and the digital data in the electronic card is protected. Consequently, the life of the electronic card and the electronic card connector are lengthened.
3. The pressing unit 5 is received inside the receiving recess 4, the thickness of the electronic card connector is smaller than the prior art. In other words, the present invention provides a small-size, light-weight and easy-to-use connector.

Although the present invention has been described with reference to the foregoing preferred embodiment, it will be understood that the invention is not limited to the details thereof. Various equivalent variations and modifications can still occur to those skilled in the art in view of the teachings of the present invention. Thus, all such variations and equivalent modifications are also embraced within the scope of the invention as defined in the appended claims.

1. A structure for an electronic card connector, comprising:
an insulating body having a universal card slot on a side thereof, wherein the universal card slot is comprised of a first surface thereinside;
a first group of pins disposed on the first surface, wherein the first group of pins comprises a plurality of conducting terminals; and
a pressing unit disposed on the first surface, the pressing unit abutting against free ends of the connecting terminals, wherein the pressing unit comprises a contacting portion disposed higher than the first group of pins, a plurality of pivoting portions, and a pressing portion;
wherein a plurality of pivoting holes is disposed on the first surface, and the pivoting portion of the pressing unit are pivotally connected with the pivoting holes and a lower surface of the pressing portion abuts against free ends of the connecting terminals;
whereby when an electronic card is inserted into the electronic card connector, a lower casing of the electronic card presses the pressing unit to move downwardly and the conducting terminals are pressed downwardly by the pressing unit.

2. The structure for an electronic card connector according to claim 1, wherein an electronic card with a first specification is inserted into the universal card slot and connects electrically with the first group of pins.

3. The structure for an electronic card connector according to claim 1, wherein a plurality of stepwise surfaces are disposed inside the universal card slot.

4. The structure for an electronic card connector according to claim 3, wherein a second surface is disposed behind the first surface inside the universal card slot, and a height of the second surface is higher than a height of the first surface.

5. The structure for an electronic card connector according to claim 4, wherein a third surface is disposed behind the second surface inside the universal card slot, and a height of the third surface is higher than the height of the second surface.

6. The structure for an electronic card connector to claim 4, wherein a second group of pins is disposed on the second surface.

7. The structure for an electronic card connector according to claim 6, wherein an electronic card with a second specification is inserted into the universal card slot and connects electrically with the second group of pins.

8. (canceled)

9. The structure for an electronic card connector according to claim 21, wherein an electronic card with a third specification is inserted into the universal card slot and connects electrically with the third group of pins.

10. The structure for an electronic card connector according to claim 1, wherein a receiving recess is disposed on the first surface and the pressing unit is received inside the receiving recess.

11. The structure for an electronic card connector according to claim 10, wherein a receiving recess has a predetermined depth allowing the pressing unit and the conducting terminals to move downwardly.

12. The structure for an electronic card connector according to claim 1, wherein the pressing portion of the pressing unit abuts against the free ends of the predetermined conducting terminals.

13. The structure for an electronic card connector according to claim 1 wherein a positioning device is disposed on at least one lateral side of the universal card slot.

14. The structure for an electronic card connector according to claim 1, wherein the insulating body further comprises a base and a cover mated with the base, and the universal card slot is defined between the base and the cover.

15. A structure for an electronic card connector, comprising:
an insulating body having a universal card slot on a side thereof, wherein the universal card slot comprises a plurality of surfaces thereinside;
a plurality of groups of pins disposed respectively on the surfaces, wherein each group of pins is comprised of a plurality of conducting terminals; and
at least one pressing unit disposed on the surfaces, the pressing unit abutting against free ends of the corresponding connecting terminals, wherein each pressing unit is disposed higher than the group of pins disposed on the same surface;
wherein a lower surface of each pressing unit abuts against free ends of the connecting terminals of the group of pins on the same surface;
whereby when an electronic card is inserted into the electronic card connector, a lower casing of the electronic card presses the pressing unit to move downwardly and the conducting terminals are pressed downwardly by the pressing unit.

16. The structure for an electronic card connector according to claim 15, wherein a plurality of stepwise surfaces are disposed inside the universal card slot and a surface closest to an opening of the universal card slot has a lowest height among the surfaces.

17. The structure for an electronic card connector according to claim 15, wherein at least one receiving recess is disposed on the surfaces corresponding to the pressing units and each pressing unit is received inside each receiving recess.

18. The structure for an electronic card connector according to claim 17, wherein each receiving recess has a predetermined depth allowing the pressing unit received therein to move downwardly.

19. The structure for an electronic card connector according to claim 15, wherein a positioning device is disposed on at least one lateral side of the universal card slot.

20. The structure for an electronic card connector according to claim 15, wherein the universal card slot is provided for electronic cards of different specifications to be inserted and connected electrically with the corresponding group of pins.

21. A structure for an electronic card connector, comprising:
an insulating body having a universal card slot on a side thereof, wherein the universal card slot is comprised of a first surface, a second surface disposed behind the first surface, and a third surface disposed behind the second surface thereinside;
a first group of pins disposed on the first surface, wherein the first group of pins comprises a plurality of conducting terminals;
a second group of pins disposed on the second surface;
a third group of pins disposed on the third surface; and
a pressing unit disposed on the first surface, wherein the pressing unit comprises a contacting portion disposed higher than the first group of pins, a plurality of pivoting portions, and a pressing portion;
wherein a plurality of pivoting holes is disposed on the first surface, and the pivoting portion of the pressing unit are pivotally connected with the pivoting holes and a lower surface of the pressing portion abuts against free ends of the connecting terminals;
whereby when an electronic card is inserted into the electronic card connector, a lower casing of the electronic card presses the pressing unit to move downwardly and the conducting terminals are pressed downwardly by the pressing unit.
